(19) United States
(12) Patent Application Publication
(10) Pub. No.: US 2010/0007274 A1
(43) Pub. Date: Jan. 14, 2010

(54) Plasma display panel

(76) Inventor: Gi-Young Kim, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/458,255

(22) Filed: Jul. 7, 2009

(30) Foreign Application Priority Data
Jul. 8, 2008 (KR) 10-2008-0066237

(51) Int. Cl. H01J 17/49

(52) U.S. Cl. 313/587; 313/584

(57) ABSTRACT

A plasma display panel (PDP) includes a front substrate and a rear substrate facing each other, a barrier rib between front and rear substrates to partition discharge cells, an address electrode extending from the rear substrate in a first direction to correspond to the discharge cell, an electromagnetic wave shield layer on an internal surface of the front substrate, and a display electrode on the front substrate separated from the electromagnetic wave shield layer and extending in a second direction that crosses the first direction to correspond to the discharge cell.

### BACKGROUND OF THE INVENTION

1. Field of the Invention

Embodiments relate to a plasma display panel (PDP). More particularly, embodiments relate to a PDP that can increase an electromagnetic wave shield effect and reduce reactive power consumption and external light reflection.

2. Description of the Related Art

A PDP displays images by using gas discharge. That is, the gas discharge generates plasma, which radiates vacuum ultraviolet (VUV) lights, which in turn excites phosphors, and the excited phosphors become stable and generate visible light of red (R), green (G), and blue (B).

In an alternating current (AC) type of PDP, a plurality of address electrodes is formed on a rear substrate, and a dielectric layer is formed on the rear substrate covering the address electrode. Barrier ribs are formed in a stripe pattern on the dielectric layer between each adjacent address electrodes. Red (R), green (G), and blue (B) phosphor layers are formed on a surface of the dielectric layer and inner surfaces of the barrier ribs.

Display electrodes, e.g., transparent electrodes and bus electrodes are formed on a front substrate perpendicular to the address electrodes. The dielectric layer and a magnesium oxide (MgO) protective layer are accumulated on an inner surface of the front substrate to cover the display electrodes.

Discharge cells are partitioned by the barrier ribs and are formed at regions where the address electrodes and the display electrodes cross. Accordingly, millions or more of the discharge cells are arranged in a matrix format in the PDP.

Since a large amount of electromagnetic waves and near infrared rays are emitted from a front surface of the PDP due to a driving characteristic of the PDP, an electromagnetic wave shield filter is attached to an external surface of the front substrate to shield the electromagnetic waves and the near infrared rays.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments are therefore directed to a PDP having advantages of increased transmittance of visible light and improved electromagnetic wave shield effect while being protected from external chemical materials and attack.

It is therefore a feature of an embodiment to provide a PDP capable of reducing reactive power consumption between an electromagnetic wave shield layer and a display electrode by decreasing a gap between the electromagnetic wave shield layer and the display electrode and by reducing a dielectric constant of a first dielectric layer that covers the electromagnetic wave shield layer.

It is therefore another feature of an embodiment to provide a PDP capable of reducing reflection of external light.

At least one of the above features and other advantages may be realized by providing a PDP including a front substrate and a rear substrate facing each other, a barrier rib between front and rear substrates to partition discharge cells, an address electrode extending from the rear substrate in a first direction to correspond to the discharge cell, an electromagnetic wave shield layer on an internal surface of the front substrate and a display electrode on the front substrate separated from the electromagnetic wave shield layer and extending in a second direction that crosses the first direction to correspond to the discharge cell.

The display electrode may include first and second electrodes respectively extended from lateral ends of the first direction of the discharge cell to the second direction. The electromagnetic wave shield layer may be between the first and second electrodes and may be extended in the second direction.

The electromagnetic wave shield layer may overlap a part of the first electrode and a part of the second electrode with respect to a direction that is perpendicular to a plane of the front substrate.

Each of the first and second electrodes may include a bus electrode extending in the second direction, and a transparent electrode protrudes to a center of the discharge cell along the first direction wherein the electromagnetic wave shield layer may overlap a part of the transparent electrode of the first electrode and a part of the transparent electrode of the second electrode.

The electromagnetic wave shield layer may form a first width defined along the first direction and the first width may be uniform along the second direction.

The electromagnetic wave shield layer may form the first width defined along the first direction, the electromagnetic wave shield layer may include a plurality of shield units, each shield unit having a second width and corresponding to a center of a discharge cell, and a plurality of connection units, each connection unit having a third width smaller than the second width and connecting adjacent shield units along the second direction, each connection unit extending from inside to outside of each respective discharge cell. The third width is smaller than a discharge gap between the first and second electrodes.

The electromagnetic shield layer may be formed as patterns covering discharge gaps between the first and second electrodes at the center of the discharge cells where electromagnetic waves are intensively generated. Each shield unit may cover the discharge gap formed between the first electrode and the second electrode at the center of the discharge cell where electromagnetic waves are intensively generated. The electromagnetic wave shield layer may be a transparent ITO pattern.

A PDP may further include a first dielectric layer covering the internal surface of the front substrate and the electromagnetic wave shield layer, and a second dielectric layer covering the display electrode formed on the first dielectric layer.

The first dielectric layer may have a dielectric constant lower than that of the second dielectric layer. The thickness of the first dielectric layer may be smaller than that of the second dielectric layer.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates an exploded perspective view of a PDP according to an exemplary embodiment.

FIG. 2 illustrates a cross-sectional view of the PDP of FIG. 1, taken along the line II-II.

FIG. 3 illustrates a top plan view of an alignment of barrier ribs, electrodes, and an electromagnetic wave shield layer according to a first exemplary embodiment.

FIG. 4 illustrates a top plan view of an alignment of barrier ribs, electrodes, and the electromagnetic wave shield layer according to another exemplary embodiment.

### DETAILED DESCRIPTION OF THE EMBODIMENTS

Korean Patent Application No. 10-2008-0066237, filed on Jul. 8, 2008, in the Korean Intellectual Property Office, and entitled: “Plasma Display Panel,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

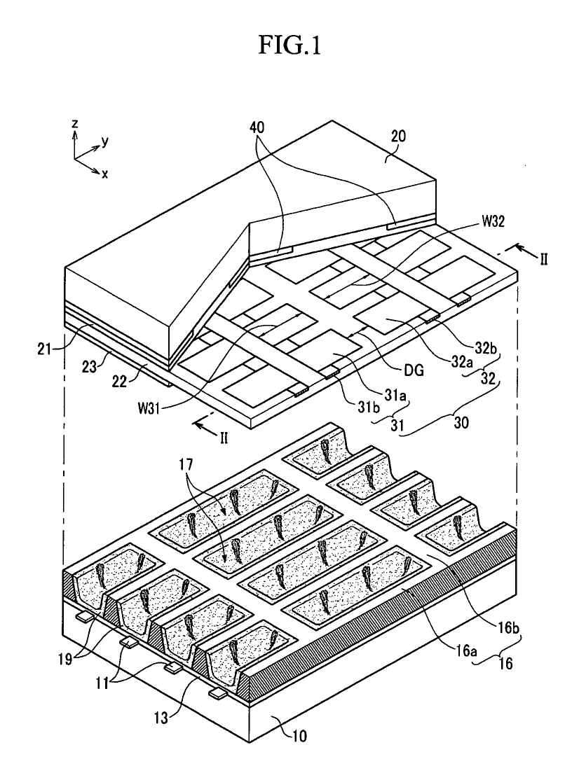

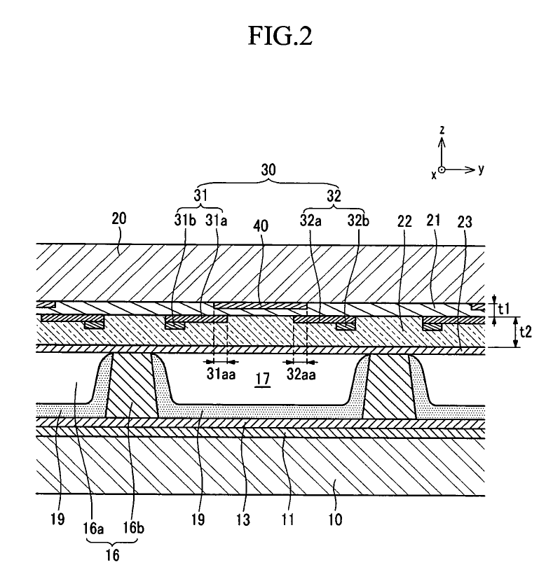

FIG. 1 illustrates an exploded perspective view of a PDP according to an exemplary embodiment, and FIG. 2 illustrates a cross-sectional view of the PDP of FIG. 1, taken along the line II-II.

Referring to FIGS. 1 and 2, the PDP according to the exemplary embodiment may include a rear substrate 10, a front substrate 20, and barrier ribs 16. The rear substrate 10 and the front substrate 20 may be disposed to face each other with a predetermined gap therebetween.

The barrier ribs 16 may be formed between the rear substrate 10 and the front substrate 20, and may partition a plurality of discharge cells 17. The discharge cells 17 are charged with a discharge gas, e.g., a mixed gas including neon (Ne) and xenon (Xe), and have a phosphor layer 19.

The gas discharge generates plasma, which radiates vacuum ultraviolet (VUV) lights which then excite the phosphor layer 19. Once excited by the VUV lights, the phosphor layer 19 stabilizes and generates visible light.

Between the rear substrate 10 and the front substrate 20, an address electrode 11 and a display electrode 30 may be interposed corresponding to each discharge cell 17 to generate the gas discharge. The display electrode 30 may include a first electrode (hereinafter referred to as a sustain electrode) 31 and a second electrode (hereinafter referred to as a scan electrode) 32.

As one example, the address electrode 11 may be formed extending in a first direction (y-axis in FIG. 1) on an internal surface of the rear substrate 10 and may correspond to each adjacent discharge cell 17 in the y-axis direction.

In addition, a plurality of address electrodes 11, each arranged in parallel with the adjacent address electrode 11, may correspond to each adjacent discharge cell 17 along a second direction (x-axis in FIG. 1) that crosses the y-axis direction.

A dielectric layer 13 may cover the internal surface of the rear substrate 10 and the address electrodes 11. The dielectric layer 13 may prevent damage to the address electrode 11 from the gas discharge, and may form and accumulate wall charges. That is, the dielectric layer 13 may prevent positive ions or electrons from directly colliding with the address electrode 11 when the discharge is generated.

The address electrode 11 may be formed as an opaque electrode, e.g., a metal electrode such as silver (Ag) having excellent electric conductivity. Since the address electrode 11 may be disposed on the rear substrate 10, it does not prevent visible light from being transmitted through the front substrate 20.

As an example, the barrier ribs 16 may be provided on the dielectric layer 13 of the rear substrate 10 to partition the discharge cells 17. The barrier ribs 16 may include first barrier rib members 16a and second barrier rib members 16b to partition the discharge cells in a matrix format.

The first barrier rib members 16a may be extended in the y-axis direction and may be disposed in parallel in the x-axis direction. The second barrier rib members 16b may be extended in the x-axis direction and may be disposed between the adjacent first barrier rib members 16a in the y-axis direction with predetermined intervals therebetween.

In addition, the barrier ribs 16 may be formed by the first barrier rib members 16a extended in the y-axis direction without including the second barrier rib members 16b. Accordingly, since the first barrier rib members 16a may be disposed in parallel in the x-axis direction, the discharge cells may be formed in a stripe pattern.

A phosphor paste may be coated on a side surface of the barrier ribs 16 and a surface of the dielectric layer 13 surrounded by the barrier ribs 16. Then the coated phosphor paste may be dried and baked to form a phosphor layer 19.

The phosphor layer 19 may have phosphor generating the same color visible light in the discharge cells 17 formed in the y-axis direction. In addition, the phosphor layer 19 may have phosphor generating red (R), green (G), and blue (B) visible light in the discharge cells 17 repeatedly disposed in the x-axis direction.

In the PDP according to the exemplary embodiment, the address electrode 11 may be on the rear substrate 10, while an electromagnetic wave shield layer 40, the sustain electrode 31, and the scan electrode 32 may be on the front substrate 20.

The electromagnetic wave shield layer 40 may be formed on an internal surface of the front substrate 20. By having the electromagnetic wave shield layer 40 on the internal surface of the front substrate 20, the electromagnetic wave shield layer 40 may be protected from the external environment and from being corroded by external chemical materials while shielding against electromagnetic waves.

A first dielectric layer 21 may cover the electromagnetic wave shield layer 40, thereby separating the electromagnetic wave shield layer 40 from the sustain electrode 31 and the scan electrode 32.

The sustain electrode 31 and the scan electrode 32, corresponding to the discharge cell 17, may be formed on the first dielectric layer 21. The sustain electrode 31 and the scan electrode 32 may form a surface discharge structure in a center portion of the discharge cell 17 to generate gas discharge in each of the discharge cells 17.

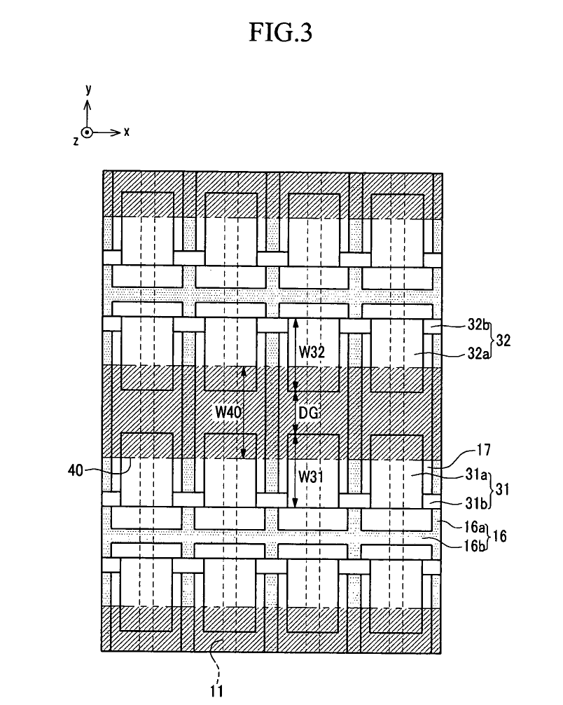

FIG. 3 illustrates a top plan view of an alignment of the barrier ribs, electrodes and the electromagnetic wave shield layer according to the first exemplary embodiment.

Referring to FIG. 3, sustain electrode 31 and scan electrode 32 may extend in the x-axis direction, perpendicular to address electrode 11. Sustain electrode 31 and scan electrode 32 respectively may include transparent electrodes 31a and 32a that may generate discharge and bus electrodes 31b and 32b that may respectively apply a voltage signal to transparent electrodes 31a and 32a.

Because transparent electrodes 31a and 32a may be disposed inside discharge cell 17, transparent electrodes 31a and 32a may be made of a transparent material, e.g., indium tin oxide (ITO), to improve an aperture ratio of the discharge cells 17. Bus electrodes 31b and 32b may be made of a metallic material having excellent electrical conductivity and are used to apply voltage signals to transparent electrodes 31a and 32a, respectively.

Transparent electrodes 31a and 32a may protrude from an opposite edge of the discharge cell 17 along the y-axis to the center of the discharge cell 17. Transparent electrodes 31a and 32a may be separated from each other by a predetermined distance at the center of the discharge cell 17. That is, transparent electrodes 31a and 32a may be formed with widths W31 and W32, respectively, and may be separated from each other at the center of the discharge cell 17 by a length of a discharge gap DG.

Bus electrodes 31b and 32b may extend along each edge of the discharge cell 17 in the x-axis direction between adjacent transparent electrodes 31a and 32a, respectively, and the first dielectric layer 21. Accordingly, the voltage signals applied to the bus electrodes 31b and 32b are respectively applied to the transparent electrodes 31a and 32a that are connected to the bus electrodes 31b and 32b and respectively corresponding to the discharge cell 17.

The electromagnetic wave shield layer 40 may be formed on the entire area of the front substrate 20, or may be formed as a pattern corresponding to an area where electromagnetic waves are intensively generated. The patterned electromagnetic wave shield layer 40 compared to the electromagnetic wave shield layer 40 covering the entire area of the front substrate 20 may have better electromagnetic wave shield efficiency while minimizing deterioration of visible light transmittance.

To improve electromagnetic wave shield effect, the pattern of the electromagnetic wave shield layer 40 may be formed at locations where the electromagnetic waves are intensively generated, e.g., between the sustain electrode 31 and the scan electrode 32.

When a sustain discharge is generated, the electromagnetic waves may be intensively generated between the sustain electrode 31 and the scan electrode 32. In more detail, the area between the transparent electrodes may intensively generate the electromagnetic waves. Therefore, the electromagnetic wave shield layer 40 may interpose between the sustain electrode 31 and the scan electrode 32.

Referring to FIGS. 2 and 3, the electromagnetic wave shield layer 40 is formed along the x-axis direction. In addition, the electromagnetic wave shield layer 40 may be disposed in parallel with the y-axis direction corresponding to the discharge cell 17.

With respect to a perpendicular direction (z-axis direction) to a plane of the front substrate 20, the electromagnetic wave shield layer 40 may overlap with a part of the sustain electrode 31 and a part of the scan electrode 32. That is, the electromagnetic wave shield layer 40 may overlap with parts 31aa and 32aa of the transparent electrodes 31a and 32a. Accordingly, the electromagnetic wave shield layer 40 may shield the discharge gap DG that intensively generates the electromagnetic waves and the electromagnetic waves around the discharge gap DG.

The electromagnetic wave shield layer 40 may have a first width W40 that is defined along the y-axis direction. The first width W40 may be uniform along the x-axis direction. The uniform first width W40 may simplify patterning of the electromagnetic wave shield layer 40.

Since the electromagnetic wave shield layer 40 may be formed in the front substrate 20 that transmits the visible light, the electromagnetic wave shield layer 40 may be made of a transparent material, e.g., an ITO pattern to transmit the visible light.

On the other hand, the conventional electromagnetic wave shield filter can be classified into a metal mesh type and a transparent conductive layer type. The metal mesh type has a superior electromagnetic wave shield performance, but it causes screen distortion due to deterioration of transparency and further increases manufacturing cost.

The transparent conductive layer type is formed of a multi-layered thin film, which alternates a metal thin film that contains silver (Ag) or an Ag alloy and a transparent thin film that contains indium tin oxide (ITO). To decrease sheet resistance of the transparent conductive layer type of the electromagnetic wave shield filter, the number of stacked metal layers should be increased. Consequently, transmittance of visible light is deteriorated.

In addition, since the metal film formed on the outer surface of the front substrate contains silver, the metal film can be easily corroded by a chemical material in the environment.

Referring back to FIGS. 1 and 2, a second dielectric layer 22 may cover an internal surface of the first dielectric layer 21, the sustain electrode 31, and the scan electrode 32. When the gas discharge is generated, the second dielectric layer 22 may protect the sustain electrode 31 and the scan electrode 32, and may form and accumulate wall charges.

The first dielectric layer 21 may have a dielectric constant that is lower than that of the second dielectric layer 22. Further, the first dielectric layer 21 may have a thickness t1 that is smaller than a thickness t2 of the second dielectric layer 22. Compared to the second dielectric layer 22, the first dielectric layer 21 may reduce reactive power consumption between the electromagnetic wave shield layer 40 and the display electrode 30 with the lower dielectric constant and the smaller thickness. In addition, although the first dielectric layer 21 partially blocks the visible light, it may reduce reflection of external light.

As an example, the first dielectric layer 21 may be made of a dielectric material having a dielectric constant from about 6 F/m to about 7 F/m and having a thickness t1 from about 16 μm to about 20 μm. The second dielectric layer 22 may be made of a dielectric material having a dielectric constant from about 11 F/m to about 13 F/m and may have a thickness t2 from about 30 μm to about 35 μm.

A protective layer 23 may cover the second dielectric layer 22. For example, the protective layer 23 may be made of transparent MgO to transmit visible light and may protect the second dielectric layer 22. The protective layer 23 may also increase a secondary electron emission coefficient when the discharge is generated.

The PDP may select discharge cells 17 to be turned on by an address discharge generated by the address electrode 11 and the scan electrode 32, and may drive the selected discharge cells 17 by sustain discharge generated from the sustain electrode 31 and the scan electrode 32 that are disposed in the selected discharge cell 17 to display an image.

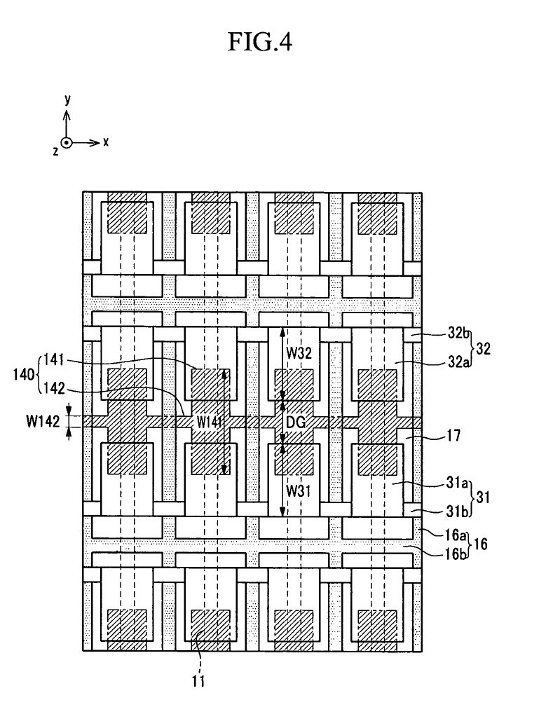

FIG. 4 illustrates a top plan view of an alignment of the barrier rib, the electrode, and the electromagnetic wave shield layer according to another exemplary embodiment.

Since an operation and a configuration of the second exemplary embodiment are the same as or similar to those of the first exemplary embodiment, descriptions of parts that have already been described will be omitted. The electromagnetic wave shield layer 140 may include shield units 141 and connection units 142 that are connected along the x-axis direction.

Each shield unit 141 may correspond to the center of a discharge cell 17 and may form a second width W 141. Each connection unit 142 may form a third width W142 that is smaller than the second width W141, and may connect each adjacent shield units 141 along the x-axis direction. Here, the second width W141 may be smaller than the discharge gap DG to increase transmittance of visible light.

The electromagnetic wave shield layer 140 may form the shield unit 141 in an area where electromagnetic waves are intensively generated to shield the electromagnetic waves. The shield units 141 are connected to each other through the connection unit 142. The shield units 141 and the connection units 142 are grounded to shield the electromagnetic wave.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a front substrate and a rear substrate facing each other;
a barrier rib between front and rear substrates to partition discharge cells;
an address electrode extending from the rear substrate in a first direction to correspond to the discharge cell;
an electromagnetic wave shield layer on an internal surface of the front substrate; and
a display electrode on the front substrate separated from the electromagnetic wave shield layer and extending in a second direction that crosses the first direction to correspond to the discharge cell.

2. The PDP as claimed in claim 1, wherein the display electrode includes first and second electrodes respectively extended from lateral ends of the first direction of the discharge cell to the second direction, and the electromagnetic wave shield layer is between the first and second electrodes.

3. The PDP as claimed in claim 2, wherein the electromagnetic wave shield layer is extended in the second direction.

4. The PDP as claimed in claim 2, wherein the electromagnetic wave shield layer overlaps a part of the first electrode and a part of the second electrode with respect to a direction that is perpendicular to a plane of the front substrate.

5. The PDP as claimed in claim 2, wherein each of the first and second electrodes includes:
a bus electrode extending in the second direction; and
a transparent electrode protruding to a center of the discharge cell along the first direction, wherein the electromagnetic wave shield layer overlaps a part of the transparent electrode of the first electrode and a part of the transparent electrode of the second electrode.

6. The PDP as claimed in claim 3, wherein the electromagnetic wave shield layer forms a first width defined along the first direction, and the first width is uniform along the second direction.

7. The PDP as claimed in claim 3, wherein the electromagnetic wave shield layer forms a first width defined along the first direction, the electromagnetic wave shield layer including:
a plurality of shield units, each shield unit having a second width and corresponding to a center of a discharge cell; and
a plurality of connection units, each connecting unit having a third width smaller than the second width and connecting adjacent shield units along the second direction, each connection unit extending from inside to outside of each respective discharge cell.

8. The PDP as claimed in claim 7, wherein the third width is smaller than a discharge gap between the first and second electrodes.

9. The PDP as claimed in claim 2, wherein the electromagnetic shield layer is formed as patterns covering discharge gaps between the first and second electrodes at the center of the discharge cells where electromagnetic waves are intensively generated.

10. The PDP as claimed in claim 7, wherein each shield unit covers the discharge gap formed between the first electrode and the second electrode at the center of the discharge cell where electromagnetic waves are intensively generated.

11. The PDP as claimed in claim 1, wherein the electromagnetic wave shield layer is a transparent ITO pattern.

12. The PDP as claimed in claim 1, further comprising:
a first dielectric layer covering the internal surface of the front substrate and the electromagnetic wave shield layer; and
a second dielectric layer covering the display electrode formed on the first dielectric layer.

13. The PDP as claimed in claim 12, wherein the first dielectric layer has a dielectric constant lower than that of the second dielectric layer.

14. The PDP as claimed in claim 12, wherein the thickness of the first dielectric layer is smaller than that of the second dielectric layer.
